(19) United States
(12) Patent Application Publication
(10) Pub. No.: US 2009/0216675 A1
(43) Pub. Date: Aug. 27, 2009

(54) Commission Centric Network Operation Systems and Methods

(75) Inventors: Leonard Antao, Smyrna, GA (US); Gerard E. Insolia, Atlanta, GA (US); H. Brock Kolls, Alpharetta, GA (US)

Correspondence Address: SUTHERLAND ASBILL & BRENNAN LLP, 999 PEACHTREE STREET, N.E., ATLANTA, GA, 30309, US

(73) Assignee: THE COCA-COLA COMPANY, Atlanta, GA (US)

(21) Appl. No.: 12/035,198

(22) Filed: Feb. 21, 2008

(51) Int. Cl. G06Q 10/00; G06Q 20/00

(52) U.S. Cl. 705/40; 705/400

(57) ABSTRACT

Embodiments of the invention can provide commission centric network operation systems and methods. In one embodiment, a commission centric network operation method can be provided. The method can include receiving an electronic transaction. The method can further include determining an electronic transaction type associated with the electronic transaction. Furthermore, the method can include determining a commission amount based at least in part on the electronic transaction type.

### TRADEMARKS

COCA-COLA® is a registered trademark of The Coca-Cola Company, Atlanta, Ga., U.S.A. Other names used herein may be registered trademarks, trademarks or product names of The Coca-Cola Company or other companies.

### TECHNICAL FIELD OF THE INVENTION

This invention relates to a vending network, and more particularly to commission centric network operation systems and methods.

### BACKGROUND OF THE INVENTION

In the vending industry, coins and bills have been one manner used to pay for vended goods and services. In this regard, when a vending account is to be settled, coins and bills can be collected from vending equipment, and the coins and bills can be reconciled with the physical inventory to determine what was sold and how much money was collected.

In recent years, cashless payments, for example credit cards, have become an option for payments. In this regard, a user of vending equipment may now be able to use cashless payments, in addition to coin and bill payments, for vended goods and services. In the case of cashless payments, a cashless payment can typically be processed by a third party server. Subsequently, an electronic funds transfer (EFT) can remit the cashless payment received, less any transaction processing fees and/or other fees, to an operator of the vending equipment. Even so, in some instances, the EFT may not reconcile an actual vend event with an associated actual cashless transaction. To further complicate matters, the vend sale amount may not match the EFT amount since fees may be deducted from the cashless funds, and oftentimes, the EFT transactions may represent an aggregated batch or bundling of multiple transactions, thus obscuring each individual vend transaction.

The processing of cashless transactions can cause numerous problems for processors handling cashless transactions, vendors offering goods and/or services by way of a vending machine accepting cashless transactions, and others involved in the cashless transaction process. For example, in one settlement process, coins, bills, and cashless transactions may not be timely reconciled with inventory since many cashless transactions may still be stored in a vending machine or other associated data storage device. In other instances, cashless transactions may still be en route to a third party server, not settled yet and/or aggregated with little or no transaction level detail. Oftentimes, only after vend settlement is initiated, may an associated EFT transaction occur, which can further frustrate the settlement process because of the aggregated nature of EFTs.

In addition, the routing of cashless transactions to one or more third party servers can also create an accountability problem. In some instances, multiple items can be vended from a vending machine, and one or more customers may attempt to pay with a cashless implement, such as a credit or debit card. However, in such instances, there is no guarantee that a vending equipment operator will ever see funds for vends paid for by cashless transactions, and no further guarantee that a customer was correctly charged for the vended goods and/or services. As such, there may be little or no accountability as to when vends occurred or what was charged to the customer. Moreover, there may be little or no accountability as to whether a customer was timely and accurately charged, and little or no assurance that a vending equipment operator timely received the correct funds for vends paid for by cashless transactions.

Furthermore, a problem exists in auditing third party servers to verify accuracy and/or correctness of cashless transactions. In this regard, cashless transaction vending can lack oversight, accountability, auditing controls, and the ability to control how a device in the vending equipment operates and how data is communicated with or between various servers or other data processing devices.

Another problem occurs when route personnel attempt to reconcile transaction amounts and inventory at a vending equipment location. In some instances, the amount of bills, coins, cashless vends, and inventory must be known at the same point in time. As related to cashless transactions, this means knowing what the value of each transaction is without any fees removed, knowing which of the cashless transactions have been settled, and also knowing which of the settled cashless transactions have a corresponding EFT record indicating that an operator of the vending equipment has been paid for the cashless transactions. Without this level of detail, it may be unlikely that an accurate or timely vending equipment settlement can be performed without error across multiple vending equipment locations. For vending equipment in global locations, the settlement process may not be performed efficiently.

Another problem is that some network service providers may want to charge a fee, such as a monthly fee, for access to their network. Though this model may be suitable for some applications, in other applications such as vending, this model may not work well. In applications such as vending, some vending equipment may generate relatively good sales while other vending equipment may not perform as well. As such, a vending equipment operator may not be able to afford to pay a fixed fee, such as a fixed monthly fee, on vending equipment that generates relatively light sales volume.

Therefore, a need exists for commission centric network operation systems and methods.

### SUMMARY OF THE INVENTION

Some or all of the above needs can be addressed by various embodiments of the invention. Embodiments of the invention can provide commission centric network operation systems and methods.

In one embodiment, a commission centric network operation method can be provided. The method can include receiving an electronic transaction. The method can further include determining an electronic transaction type associated with the electronic transaction. Furthermore, the method can include determining a commission amount based at least in part on the electronic transaction type.

In another embodiment, a commission centric network operation system can be provided. The system can include a server operable to receive an electronic transaction, wherein at least one state field is associated with the electronic transaction. The server can be further operable to determine said electronic transaction type. Furthermore, the server can be operable to determine a commission amount for the electronic transaction based at least in part on a type of electronic transaction, when the at least one state field is determined to be a predefined state.

In another embodiment, a method for providing a commission to a merchant can be provided. The method can include receiving an electronic transaction. The method can also include determining an electronic transaction type associated with the electronic transaction. In addition, the method can include determining a commission amount based at least in part on at least one of the following: volume of transactions, amount of transactions, a predefined fee, or electronic transaction type.

Other embodiments and aspects of the invention are described in detail herein and are considered a part of the claimed invention. For a better understanding of embodiments of the invention with features and aspects, refer to the description and to the drawings.

### BRIEF DESCRIPTION OF THE FIGURES

The foregoing and other features, and aspects of the invention are apparent from the following detailed description taken in conjunction with the accompanying drawings in which:

FIG. 1 illustrates an example commission centric network operation system in accordance with an embodiment of the invention.

FIGS. 2A-2B illustrates an example commission centric network operation method in accordance with an embodiment of the invention.

FIG. 3 illustrates an example commission centric network operation method implemented using a state field in accordance with an embodiment of the invention.

FIG. 4 illustrates an example commission centric network operation method implemented using a state field and reconciliation token in accordance with an embodiment of the invention.

### DETAILED DESCRIPTION OF EMBODIMENTS OF THE INVENTION

As used herein, the term “transaction” can refer to a cash or cashless payment associated with a purchase of a good and/or service. Embodiments of the invention are intended to cover any combination of cash and/or cashless payments or transactions as well as payments or transactions relating to any combination of goods and/or services.

As used herein, the terms “server switch” and “server” can be used interchangeably. Embodiments of the invention are intended to cover any combination of servers, server switches, or other processing devices with similar functionality to a server or server switch.

As used herein, the terms “reconciliation token” and “unique identifier” can be used interchangeably. Embodiments of the invention are intended to cover any type of unique identifier including, but not limited to, a reconciliation token or any other device, code, or identifying instrument with similar functionality.

As used herein, the term “commission” can refer to any fee or amount paid to an entity, which may or may not be, in addition to a fee such as a processing fee. A commission can include, but is not limited to, a predefined fee or a fee based on a percentage or portion of one or more transactions, transaction types, or any combination of associated transaction data.

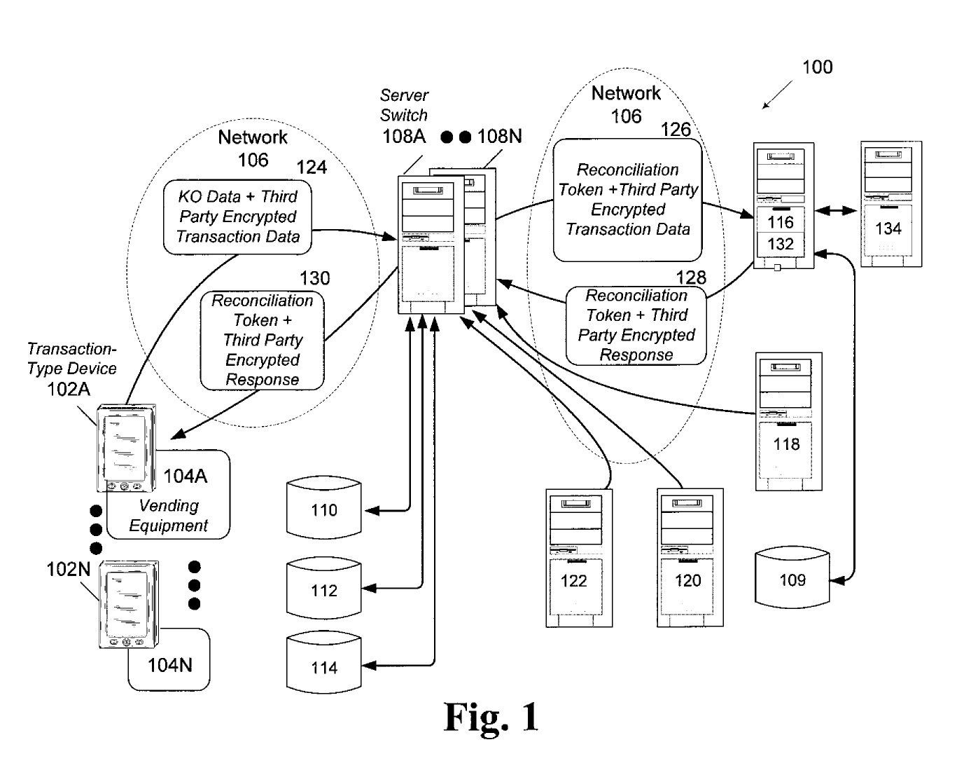

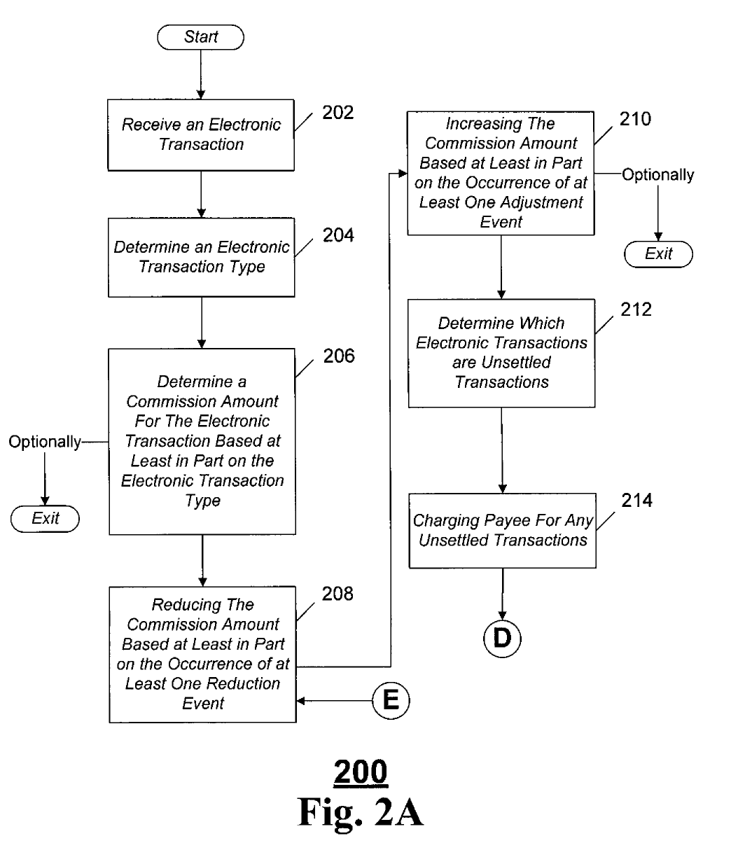

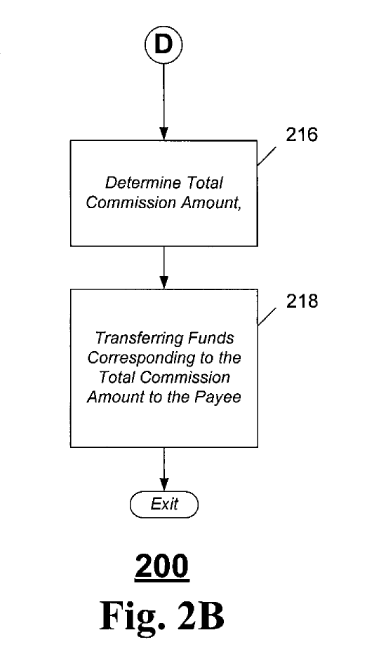

Referring now to FIG. 1, an example of a system 100 in accordance with an embodiment of the invention is shown. Embodiments of the invention can provide commission centric network operation systems and methods. Example methods associated with the system 100 shown in FIG. 1 are described in FIGS. 2A-2B, 3 and 4.

In the embodiment shown in FIG. 1, a system 100 can include one or more transaction devices 102A-N associated with respective vending equipment 104A-N. Some or all of the transaction-type devices 102A-N can be in communication via at least one network, such as 106, with one or more server switches, such as 108A-N. In one embodiment, one or more transaction-type devices 102A-N can be in communication with each other via one or more networks, such as 106.

Transaction-type devices 102A-N can be any processor-type device, and may be referred to individually as a data processing device. Some or all transaction-type devices 102A-N can be operable to receive and transmit data associated with at least one cash and/or cashless transaction, or a consumer. Such data may be referred to as transaction data. Transaction data can include, but is not limited to, vending equipment load-to-load (also referred to as fill-to-fill) information, vend transaction matching and reconciliation processing data, electronic fund transaction (EFT) reconciliation data, cash vending transactions, cashless vending transactions, cashless transaction data, cash transaction data, transaction records, DEX data, MDB data, transaction refunds (also referred to as reversals) data, accounting data, auditing data, electronic funds charge back data, route management data, business management data, and any other type of data associated with a vending equipment transaction or a consumer. Examples of transaction-type devices can include, but are not limited to, a cash transaction reader, a cashless transaction reader, a combination cash and cashless transaction reader, a RFID reader, a biometric reader, an energy management system (EMS)-type device, a vending machine controller (VMC), and any other type of payment transaction devices. In some instances, a transaction device can be manufactured by HP™, DELL™, IBM/LENOVO™, and GATEWAY™, and may operate software provided by MICROSOFT™, and LINUX™.

In one embodiment, a transaction-type device, such as 102A, can be a payment device operable to accept a cash and/or cashless payment from a consumer, and further operable to facilitate the dispensing of goods and/or services from associated vending equipment, such as 104A. In another embodiment, a transaction-type device, such as 102A, can be a vending equipment controller operable to facilitate the operation of associated vending equipment, such as 104A.

Vending equipment 104A-N can include, but is not limited to, a product or beverage dispenser, a vending machine, a snack dispenser, a device capable of dispensing or providing a consumable food or drink item, a device capable of dispensing or providing a non-consumable item, or a device capable of facilitating purchase of a good and/or service. Vending equipment, such as 104A, can also be referred to individually as a vending machine. In some embodiments, vending equipment 104A-N may conform to vending industry standards including, but not limited to, the National Automatic Merchandising Association (NAMA) MDB specification, and the European Vending Association (EVA) DEX specification. In one embodiment, vending equipment 104A-N can include a vending industry standard-type multi-drop-bus (MDB) interface, and/or a data exchange (DEX) interface.

In one embodiment, multi-drop-bus (MDB) data can be collected from vending equipment, such as 104A-N, and the collected MDB data used to form transaction data records. In this regard, MDB data can include, but is not limited to, inventory, product pricing, and other data during vend events that can be combined with payment ID (for example a PIN number or credit card number) to form a transaction record. In addition, MDB data can be collected during non-vend events and used to form transaction records such as service requests, energy management records, and other types of transaction records.

In the embodiment shown in FIG. 1, a network 106 can be wired or wireless-type network, and may be more than one network to facilitate both wired and wireless-type communications between system components. The network 106 shown in FIG. 1 is shown by way of example. Examples of a network 106 can include, but are not limited to, a local area network (LAN), a wide area network (WAN), the Internet, a global network, a wireless network, a wired network, and any combination thereof. Wireless network communications can be implemented, for example, by way of GSM, GPRS, CDMA2000, 1XRTT, EDGE, 802.11 types and kinds including but not limited to ‘a’, ‘b’, ‘g’, ‘n’, 900 MHz, 2.4 GHz, 5 GHz, spread spectrum, open wireless standards, proprietary wireless techniques, 3G, 3.5G, 4G technologies (‘G’ stands for generation), and any other wireless-type communication device, standard, or methodology. Wired network communications can be implemented, for example, by way of Ethernet, Firewire, serial communications, USB, RS232, and any other wired-type communication device, standard, or methodology. In one embodiment, a network can be the Internet, which may be referred to as a global network.

In the embodiment shown, a server switch 108A can be a processor-based platform, such as a server. In one embodiment, a server switch 108A can be operable to store a copy of some or all of transaction data received from one or more transaction devices 102A-N. The server switch 108A may store some or all of the transaction data in an associated database or data storage device, such as 110, 112, or 114. In another embodiment, a server switch, such as 108A, can be operable to generate a unique identifier, such as a reconciliation token, and associate the unique identifier or token with or otherwise add the unique identifier or token to a transaction record. In some embodiments, a server switch, such as 108A, can generate and associate a unique identifier or reconciliation token with some or all transactions which may be transmitted via a network, such as 106, by the system 100.

As shown in FIG. 1, the system 100 can also facilitate communications with one or more servers 116, 118, 122 and/or third parties 120. In the embodiment shown, some or all of the transaction-type devices 102A-N can be in communication with at least one of the following: a vend settlement server 116, a data services server 118, a financial institution 120, a third party server 122, and/or any device associated with a third party. In this embodiment, a transaction-type device, such as 102A, can transmit data via a network, such as 106, to a server switch, such as 108A. The server switch 108A can selectively transmit some or all of the received data to another transaction-type device, such as 102N; another server switch, such as 108N; a vend settlement server, such as 116; a data services server, such as 118; a financial institution, such as 120; a third party server, such as 122; or any other device associated with a third party. Data received by a vend settlement server 116, a data services server 118, a financial institution 120 and/or a third party server 122 can be stored in an associated database, such as 109, or other data storage device.

In one embodiment, a transaction-type device, such as 102A, can transmit data to a vend settlement server, such as 116, via a network, such as 106, and server switch, such as 108A. Data initially received or otherwise collected by the transaction-type device 102A can be transmitted to the server switch 108A in a format such as a data packet 124. The data can include, but is not limited to, vending equipment load-to-load (also referred to as fill-to-fill) information, vend transaction matching and reconciliation processing data, electronic fund transaction (EFT) reconciliation data, cash vending transactions, cashless vending transactions, cashless transaction data, cash transaction data, transaction records, DEX data, MDB data, transaction refunds (also referred to as reversals) data, accounting data, auditing data, electronic funds charge back data, route management data, business management data, and/or any other type of data associated with a vending equipment transaction or a consumer. Ultimately, some or all of the data can be transmitted by the server switch, such as 108A, to a vend settlement server, such as 116.

In one embodiment, one or more reconciliation tokens can facilitate auditing some or all of the transaction data handled by one or more vend settlement servers 116 and/or third party servers 122. For example, a server switch, such as 108A, can communicate at least one reconciliation token with each transaction to a vend settlement server 116 and/or third party server 122, and receive transaction data from the vend settlement server 116 and/or third party server 122 in response to each reconciliation token. In this example, a server switch 108A can transmit at least one reconciliation token in a data packet 126 to a vend settlement server 116 and/or third party server 122. In response to the receiving one or more reconciliation tokens, the vend settlement server 116 and/or third party server 122 can transmit a data packet 128 with response data including the one or more reconciliation tokens to the server switch 108A. Such response data can be compared to previously transmitted transaction data or other data previously stored in a database, such as 110, 112, or 114, or other data storage device associated with the server switch 108A. In one embodiment, a vend settlement server such as 116 can be referred to as a third party server and can be audited in a similar manner described above.

Furthermore, in one embodiment, a server switch, such as 108A, can be operable to switch or otherwise transfer one or more transaction records between various destination servers. For example, transaction data stored on a particular server can be transferred to another server by way of a server switch, such as 108A. Moreover, a server switch 108A can be operable to issue a data packet 130 with one or more reconciliation tokens in response to transaction data received or transmitted by the server switch 108A. In addition, a server switch 108A can be operable to maintain at least one transaction database for storing transaction data, such as a plurality of databases including a KO database 110, reconciliation database 112, and device database 114.

In one embodiment, a server switch, such as 108A, can be operable to control access to a network, such as 106, by inspecting each transaction received at the server switch 108A. For example, before passing transaction data from a transaction-type device, such as 102A, to a destination location, the server switch 108A can check a database, such as the device database 114, to ensure that the transaction-type device, for instance 102A, from which the transaction is received is allowed to use the network 106. If the transaction-type device 102A is not allowed to use the network 106, the transaction data is not forwarded to the destination location and optionally the transaction-type device 102A can be informed by the server switch 108A that access to the network 106 is denied.

In another embodiment, a server switch, such as 108A, can be operable to control the types or classes of transactions a particular transaction-type device, such as 102A, is allowed to transmit on a network, such as 106. In this regard, the server switch 108A can inspect the type or class of transaction being transmitted, compare each transaction type or class to one or more allowed or otherwise predefined types or classes of transactions stored in a database, such as device database 114, and determine if such a transaction is allowed from the particular transaction-type device 102A. For example, if a transaction-type device 102A is deployed to accept a particular class of transactions, such as hotel room key cards, the server switch 108A can prevent or otherwise limit some or all other transactions, such as non-hotel room key cards, from being used.

As shown in FIG. 1, a vend settlement server, such as 116, can include a property management system program module 132. The property management system program module 132 can be a set of computer-executable instructions stored in a processor or memory associated with the vend settlement server 116. The property management system program module 132 can be operable to receive one or more electronic transactions from at least one transaction-type device, such as 102A-N. Furthermore, the property management system program module 132 can be operable to reconcile one or more electronic transactions. In addition, the property management system program module 132 can be operable to communicate response data for each electronic transaction to at least one server switch, such as 108A. In some embodiments, a property management system program module can be stored in other computer-readable media, such as memory or data storage devices associated with other servers, databases, or other processor-based or storage-based devices including, but not limited to, 108A-N, 109, 110, 112, 114, 118, 120, 122, 134. In this manner, a system such as 100 can facilitate providing commission centric network operation in accordance with embodiments of the invention as described herein.

A program module, such as a property management system program module 132, can be encoded in a variety of computer languages including, but not limited to, JAVA, PERL, PHP, PYTHON, C, C#, C++, VB.NET, VISUAL BASIC, scripting languages, assembler code, or any other type of programming language and or scripting language. A program module can be referred to, individually or collectively, as software, computer code, data, files, object files, or assembler code applications and can be embodied on any suitable machine readable medium. A machine readable medium can include, but is not limited to, a CDROM, DVD, a hard drive, a micro drive, flash memory, memory, a disk drive, a networked device, a data processing device, a data processing resource, and other types of computer-readable mediums. In one embodiment, various functions or code associated with a program module such as 132 could be distributed between multiple processing devices, such as vend settlement server 116 and another server, or may reside in a single processing device, such as 116 or 120.

In one embodiment, the system 100 can process transactions associated with hotel room keys. For example, one or more hotel room key cards can be utilized to allow hotel guests to use a respective hotel room key card at one or more transaction-type devices, such as 102A-N. In some instances, a hotel guest may desire to have a product or service purchase added to his or her portfolio or invoice managed by a property management system program module, such as 132. In this regard, by using his/her hotel room key card, a guest can have his/her purchases at transaction-type devices 102A-N billed to his/her room and pay for the vended products and/or services when the hotel bill is paid.

In one embodiment, one or more transaction-type devices, such as 102A-N, can generate and send transaction data, such as data packet 124, to a server switch, such as 108A. In certain instances, an entity such as property management may not want certain transaction data, such as hotel key card data, to leave the premises for security reasons, and the use of a wide area network (WAN) configuration where a server switch is located at a remote location may not be acceptable to property management. One aspect of a server switch, such as 108A, can be the location of the server switch at or on property owned or otherwise controlled by property management. In this manner, a server switch, such as 108A, can communicate with a plurality of transaction-type devices, such as 102A-N, which may be hotel key card reading devices, and also communicate with the property management system program module, such as 132.

In one embodiment, certain transaction data such as hotel key card data can remain onsite, but other transaction data, such as credit card transactions, sales information, inventory, service, and other data may be acceptable to communicate remotely. In this example, a first server switch, such as 108A, can communicate with one or more other server switches, such as 108B, and as necessary, to one or more vend settlement servers, such as 116, third party servers, such as 122, operator servers, such as 134, and/or to other data processing equipment.

In one embodiment, a server switch, such as 108A, can be integrated into at least one transaction-type device, such as 102A-N. In this example, at least one of a plurality of transaction-type devices, such as 102A-N, can function as a server switch in addition to performing various features and functions as a transaction-type device, such as 102A-N. In this regard, a system in accordance with an embodiment of the invention may implement one or more micro-type server switches with respective transaction-type devices rather than having an independent server switch serving the transaction-type devices. In one embodiment, at least one financial institution such as 120 can receive transaction data associated with one or more transaction-type devices 102A-N via one or more servers, such as 108A-N. The financial institution 120 could determine an electronic transaction type associated with the electronic transaction, and determine a commission amount based at least in part on the electronic transaction type, wherein the commission amount can be charged to a payee or other entity. For example, a financial institution such as a credit or debit card issuer, or a bank associated with a credit or debit card issuer, can operate or otherwise host a server associated with the financial institution, such as 120. The server can determine various commission amounts to be charged to or otherwise paid to participating merchants, such as third party terminal companies. In this manner, various merchants can be compensated by way of a commission for transactions facilitated by one or more vending machines, wherein the commission can be a predefined fee or a fee based on a percentage or portion of one or more transactions, transaction types, or any combination of associated transaction data.

Referring to FIGS. 2A and 2B, an example commission centric network operation method 200 in accordance with an embodiment of the invention is shown. The method 200 can be implemented using some or all of the system components shown in FIG. 1, and in this example, some of the system components of system 100 are utilized. In one embodiment, a commission centric network operation method can facilitate payment of commissions to a designated payee in lieu of any monthly and/or other types of fees. In another embodiment, a commission can be paid for each transaction completed. In any instance, a commission amount can vary based at least in part on the number of transactions or the transaction type, can be a predefined fee, or can be based on a percentage or a portion of one or more transactions, transaction types, or any combination of associated transaction data. In any of these instances, the commission can be increased or decreased depending on adherence to a predefined set of rules and conditions, such as a set of best practices. Since commissions may be paid on completed electronic transactions, it may matter less to an operator of vending equipment whether the vending equipment is a relatively good or poor sales performer, as recurring monthly fees can be eliminated or minimized.

In one embodiment, a server switch, such as 108A, can be configured to monitor electronic transactions as transactions are communicated via a network, such as 106. In this regard, the server switch, such as 108A, can determine when an electronic transaction is complete, and further determine a commission amount to be accrued and paid in the form of a total commission amount to a designated payee. For example, a commission amount can be determined for an electronic transaction based at least in part on the transaction type and/or other factors. In this example, one commission amount can be paid for a credit card transaction, a different commission amount can be paid for a DEX data file, and yet a different commission amount can be paid for bill and/or coin transactions. In addition, optionally the server switch, such as 108A, can make certain determinations regarding an electronic transaction and impose an increase or decrease in a predefined commission amount. For example, if a credit card or other type of transaction is delayed in settlement beyond particular duration of time, a server switch, such as 108A, can impose a penalty for the delay, thereby reducing a predefined commission amount for the credit card or other type of transaction. In another example, if a DEX data file is scheduled to arrive by midnight, and no DEX data file is received by midnight at the server switch, such as 108A, the server switch, such as 108A, can reduce a predefined commission amount or otherwise impose a fee for untimely receipt of the DEX data file.

An electronic transaction described herein can include, but is not limited to, a credit card transaction, a debit card transaction, a cash and/or cashless transaction, a bill and/or coin transaction, a DEX data communication, MDB data communication, a hotel key card transaction, and other types of transactions capable of being processed by embodiments of a commission centric network system, such as 100.

The method 200 begins at block 202. In block 202, an electronic transaction is received. In this embodiment, a server switch, such as 108A, can receive and monitor an electronic transaction. The server switch, such as 108A, can receive an electronic transaction from a transaction-type device, such as 102A-N, via a network, such as 106.

Block 202 is followed by block 204, in which an electronic transaction type is determined. In this embodiment, the server switch, such as 108A, can determine an electronic transaction type associated with the received electronic transaction. Types of electronic transactions can include, but are not limited to, a credit card transaction, a debit card transaction, a cash and/or cashless transaction, a bill and/or coin transaction, a DEX data communication transaction, MDB data communication transaction, a hotel key card transaction, and other types of transactions capable of being processed by embodiments of a commission centric network system, such as 100.

Block 204 is followed by block 206, in which a commission amount is determined for the electronic transaction based at least in part on the electronic transaction type. In this embodiment, the server switch, such as 108A, can determine or otherwise accrue a commission amount based at least in part on the electronic transaction type associated with an electronic transaction. For example, for certain transaction types, one predefined commission amount can be determined, and for other transaction types, another predefined commission amount may be determined. In the embodiment shown, a commission amount can be associated with a designated payee. The designated payee can be an individual or entity that is to be the recipient of a total commission amount. In another embodiment, commission amount can be based at least in part on the volume of transactions, amount of transactions, a predefined fee, or electronic transaction type. In one embodiment, the method 200 can optionally end after block 206. In other embodiments, the method 200 can continue at block 208.

In block 208, the commission amount can be reduced based at least in part on the occurrence of at least one reduction event. In this embodiment, the server switch, such as 108A, can determine whether to reduce or otherwise adjust the commission amount based at least in part on the occurrence of at least one reduction event, such as if the time between the electronic transaction authorization and the electronic transaction settlement exceeds a predetermined time period. For example, if an electronic transaction is a credit card transaction, the interchange or processing rates charged by a financial processing institution can be higher when the credit card is not timely settled. As such, to encourage the designated payee to be prompt in settling electronic transactions, thereby avoiding interchange penalties, the commission amount paid to the designated payee for processing the delayed electronic transaction can be reduced.

In one embodiment, a commission amount for an electronic transaction can be reduced if the difference between the authorization amount and the settlement amount exceeds a predetermined margin. As such, if the difference between the authorized and settled amount exceeds a predetermined margin, a penalty can be imposed on the designated payee by reducing the commission amount paid for the electronic transaction.

In one embodiment, if an electronic transaction is a credit card transaction, the interchange or processing rates charged by some processing companies can be relatively higher when a credit card authorized amount is excessively different from the settlement amount. As such, to avoid or otherwise minimize interchange penalties and encourage the designated payee to operate one or more transaction-type devices, such as 102A-N, such that the settled electronic transaction sale amount is close to the authorized amount, the commission amount paid, for processing such out-of-range electronic transactions, can be reduced. Out-of-range can be defined herein as the circumstance where the difference between the electronic transaction authorization amount and settlement amount exceeds a predetermined value.

Block 208 is followed by block 210, in which the commission amount can be increased based at least in part on the occurrence of at least one adjustment event. In this embodiment, the server switch, such as 108A, can determine whether to increase or otherwise adjust the commission amount based at least in part on the occurrence of at least one adjustment event, such as if certain electronic transaction types are received in accordance with a predetermined schedule. For example, if a DEX data file is scheduled to be received by midnight, and the file arrives on time prior to or at midnight, the commission amount can be increased. The method 200 can optionally end after block 210, or can continue to block 212.

In any instance, reducing and/or increasing commission amounts can be utilized to encourage manufacturers and operators of transaction-type devices, such as 102A-N, to adhere to certain rules, such as best practices, when managing transaction-type device operations. For example, a server switch, such as 108A, can implement any number of rules, such as best practices, to determine whether to reduce and/or increase commission amounts associated with certain transactions, transaction types, and various combinations thereof. Block 210 is followed by block 212, in which a determination is made which electronic transactions are unsettled transactions. In this embodiment, the server switch, such as 108A, can determine which electronic transactions are unsettled transactions. For example, the server switch, such as 108A, can conduct an audit of some or all electronic transactions to determine whether any of the electronic transactions are unsettled electronic transactions. In this example, each of the unsettled electronic transactions can include an electronic transaction unsettled sale amount.

Block 212 is followed by block 214, in which a payee can be charged for any unsettled transactions. In this embodiment, the server switch, such as 108A, can charge a payee, such as a designated payee, for unsettled or otherwise incomplete electronic transactions. Unsettled electronic transactions can be defined herein as transactions that were initially authorized and corresponding products and/or services were possibly dispensed and/or sold, yet the transactions were not settled. As such, payment has not been provided to the product and/or service supplier or manufacturer. In this example, a penalty can be enforced on a payee, such as a designated payee, to encourage adherence to a set of rules, such as best practices, to ensure that some or all authorized transactions are settled.

Block 214 is followed by block 216, in which a total commission amount is determined. In this embodiment, the server switch, such as 108A, can determine a total commission amount. As defined herein, a total commission amount is a total amount that includes any cumulative commission amounts and any fee deductions from some or all electronic transactions processed. In addition, any applicable commission reductions and/or increases can be accounted for in the total commission amount.

Block 216 is followed by block 218, in which funds corresponding to the total commission amount are transferred to the payee. In this embodiment, the server switch, such as 108A, can facilitate the transfer of funds in the amount of the total commission amount to the payee, such as a designated payee. A funds transfer can be facilitated by, for example, an electronic funds transfer (EFT) or any other method or device. For example, the server switch 108A can facilitate a funds transfer by transmitting corresponding funds transfer instructions to a financial institution, such as 120, and providing authorization for such instructions and/or funds transfer. In one embodiment, a transfer of funds to a payee can be initiated when certain predefined criteria have been reached or met. For instance, predefined criteria can include, but are not limited to, at a predefined time interval, at a predefined date or time, when the total commission amount reaches a predetermined amount, when a predetermined count of plurality of electronic transactions is reached, upon request by a payee, and designated payee or a representative of the designated payee. The method 200 ends after block 218.

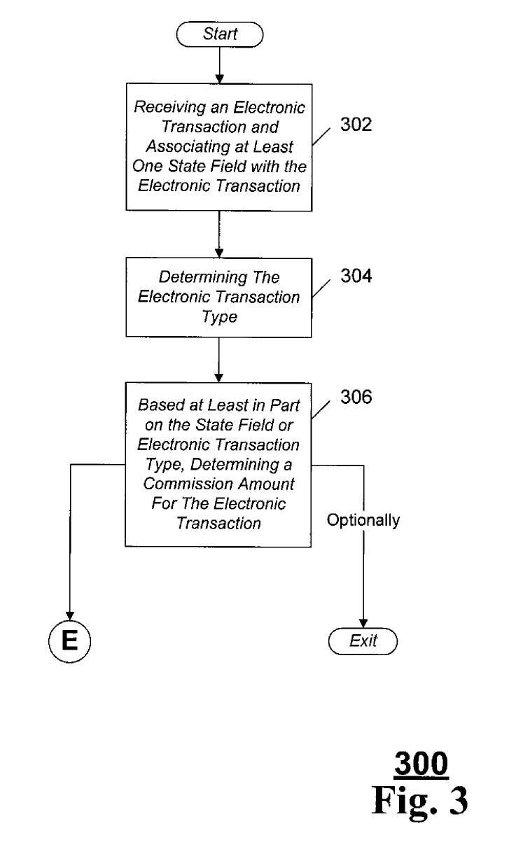

Referring to FIG. 3, an example commission centric network operation method implemented using a state field in accordance with an embodiment of the invention is shown. In one embodiment, at least one state field can be utilized to determine when an electronic transaction is complete. A determination of completeness can serve as or otherwise provide a trigger to generation of a commission amount for the completed electronic transaction. The method 300 begins in block 302.

In block 302, an electronic transaction is received and at least one state field is associated with the electronic transaction. In this embodiment, a server switch, such as 108A, can receive and monitor an electronic transaction. The server switch, such as 108A, can receive an electronic transaction from a transaction-type device, such as 102A-N, via a network, such as 106. The server switch, such as 108A, can associate at least one state field with the electronic transaction, wherein the state field can indicate when or if the electronic transaction has been completed. For example, an electronic transaction, such as a credit card transaction, may first be authorized, a sale performed, and then the transaction can be settled. The server switch, such as 108A, can, by monitoring one or more state fields and associated states of each of the electronic transactions communicated via a network, such as 106, determine when or if an electronic transaction has been completed, i.e. when the credit card transaction is settled. In this manner, the server switch, such as 108A, can facilitate the generation of a commission amount to be accrued when the electronic transaction is completed.

Block 302 is followed by block 304, in which an electronic transaction type is determined. In this embodiment, the server switch, such as 108A, can determine an electronic transaction type associated with the received electronic transaction. Types of electronic transactions can include, but are not limited to, a credit card transaction, a debit card transaction, a cash and/or cashless transaction, a bill and/or coin transaction, a DEX data communication transaction, MDB data communication transaction, a hotel key card transaction, and other types of transactions capable of being processed by embodiments of a commission centric network system, such as 100.

Block 304 is followed by block 306, in which based at least in part on the state field, a commission amount for the electronic transaction can be determined. In this embodiment, when the server switch, such as 108A, determines the state field includes an indication that the electronic transaction is complete, the server switch, such as 108A, can determine a commission amount for the electronic transaction. In one embodiment, a commission amount can include or otherwise cover any associated transaction processing fees for the particular electronic transaction. Transaction processing fees can include, but are not limited to, fees imposed on credit card transactions as they are processed through a financial institution or a financial processing institution.

In one embodiment, a commission amount can be determined for the electronic transaction based at least in part on the type of electronic transaction. For example, a commission amount can be associated with a particular electronic transaction type such as a transaction associated with a certain payee, or a designated payee. In this example, a payee, such as a designated payee, can be an individual or entity that is to be the recipient of the total commission amount. A server switch, such as 108A, can determine a predefined commission amount or otherwise calculate a commission amount. The method 300 can either end after block 306, or continue at block 208 in FIG. 2.

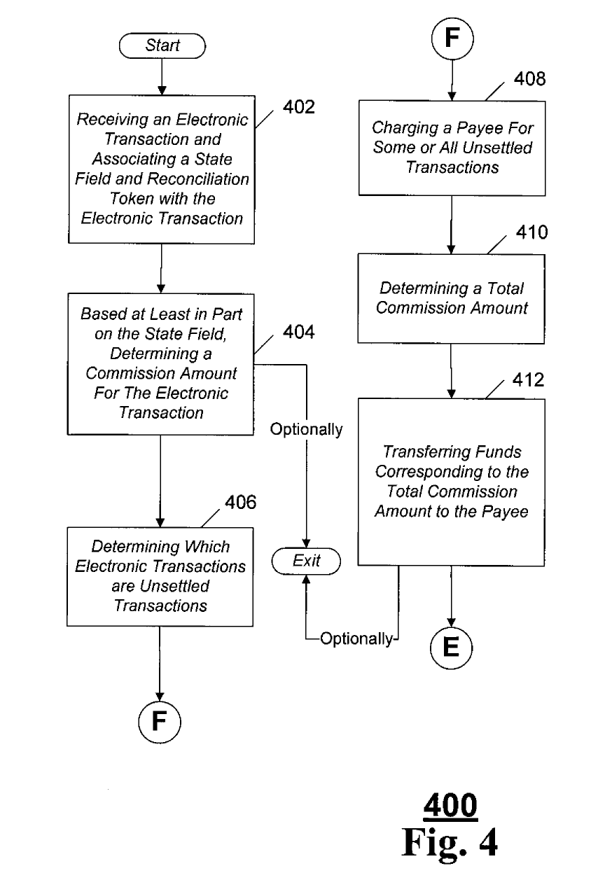

Referring to FIG. 4, an example commission centric network operation method implemented using a state field and reconciliation token is shown in accordance with an embodiment of the invention. In one embodiment, at least one state field and at least one reconciliation token can be used to account for and audit an electronic transaction.

The method 400 begins in block 402.

In block 402, an electronic transaction is received and at least one state field and at least one reconciliation token are associated with the electronic transaction. In this embodiment, a server switch, such as 108A, can receive and monitor an electronic transaction. The server switch, such as 108A, can receive an electronic transaction from a transaction-type device, such as 102A-N, via a network, such as 106. The server switch, such as 108A, can associate at least one state field and at least one reconciliation token with the electronic transaction. For example, a state field can indicate when an electronic transaction has been completed. By way of further example, a reconciliation token can be operable to audit a destination server. Suitable example state fields and reconciliation tokens are discussed above.

Block 402 is followed by block 404, in which based at least in part on the state field, a commission amount for the electronic transaction can be determined. In this embodiment, when the server switch, such as 108A, determines whether the state field includes an indication that the electronic transaction is complete, the server switch, such as 108A, can determine a commission amount for the electronic transaction. In one embodiment, a commission amount can include or otherwise cover any associated transaction processing fees for the particular electronic transaction. Transaction processing fees can include, but are not limited to, fees imposed on credit card transactions as they are processed through a financial institution or a financial processing institution.

In one embodiment, a commission amount can be determined for the electronic transaction based at least in part on the type of electronic transaction. For example, a commission amount can be associated with a particular electronic transaction type such as a transaction associated with a certain payee or a designated payee. In this example, a payee, such as a designated payee, can be an individual or entity that is to be the recipient of the total commission amount. A server switch, such as 108A, can determine a predefined commission amount or otherwise calculate a commission amount.

The method 400 can either end after block 404 or continue at block 406.

In block 406, a determination is made which electronic transactions are unsettled transactions. In this embodiment, the server switch, such as 108A, can determine which electronic transactions are unsettled transactions. For example, the server switch, such as 108A, can conduct an audit of some or all received electronic transactions to determine whether any of the electronic transactions are unsettled electronic transactions. In this example, an audit can be performed by using one or more reconciliation tokens. The results of the audit can be used to determine whether any of the electronic transactions are unsettled electronic transactions. Some or all of the unsettled electronic transactions can include an unsettled sale amount.

Block 406 is followed by block 408, in which a payee can be charged for some or all unsettled transactions. In this embodiment, the server switch, such as 108A, can charge a predefined fee to a payee, such as a designated payee, for some or all unsettled or otherwise incomplete electronic transactions. Unsettled electronic transactions can be defined herein as transactions that were initially authorized and corresponding products and/or services were possibly dispensed and/or sold, yet the transactions were not settled. As such, payment has not been provided to the product and/or service supplier or manufacturer. In this example, a fee can be levied on a payee, such as a designated payee, to encourage adherence to a set of rules, such as best practices, to ensure that some or all authorized transactions are settled.

Block 408 is followed by block 410, in which a total commission amount is determined. In this embodiment, the server switch, such as 108A, can determine a total commission amount. As defined herein, a total commission amount is a total amount that includes any cumulative commission amounts and any fee deductions from some or all electronic transactions processed. A server switch, such as 108A, can determine a predefined commission amount or otherwise calculate a commission amount as a total commission amount.

Block 410 is followed by block 412, in which funds corresponding to the total commission amount are transferred to the payee. In this embodiment, the server switch, such as 108A, can facilitate the transfer of funds in the amount of the total commission amount to the payee, such as a designated payee. A funds transfer can be facilitated by, for example, an electronic funds transfer (EFT) or any other method or device. For example, the server switch 108A can facilitate a funds transfer by transmitting corresponding funds transfer instructions to a financial institution, such as 120, and providing authorization for such instructions and/or funds transfer. In one embodiment, a transfer of funds to a payee can be initiated when certain predefined criteria have been reached or met. For instance, predefined criteria can include, but are not limited to, at a predefined time interval, at a predefined date or time, when the total commission amount reaches a predetermined amount, when a predetermined count of plurality of electronic transactions is reached, upon request by a payee, and designated payee or a representative of the designated payee. The method 400 can either end after block 410, or continue at block 208 in FIG. 2, in which adjustments to the commission amount can be determined.

The capabilities of various embodiments of the invention can be implemented in software, firmware, hardware or some combination thereof.

As one example, one or more aspects of embodiments of the invention can be implemented in an article of manufacture (e.g., one or more computer program products) having, for instance, computer usable media. The media has embodied therein, for instance, computer readable program code as a means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of an embodiment of the invention can be provided.

The flow diagrams depicted herein are just examples. There may be many variations to these diagrams or the elements (or operations) described therein without departing from the scope of the invention. For instance, the elements may be performed in a differing order, or elements may be added, deleted or modified. All of these variations are considered a part of the claimed invention.

While various embodiments of the invention have been described, it will be understood that those skilled in the art, both now and in the future, may make various improvements and enhancements which fall within the scope of the claims which follow. These claims should be construed to maintain suitable protection for embodiments of the invention described herein.

1. A commission centric network operation method comprising:
receiving an electronic transaction associated with dispensing a good or service;
determining, via at least one processor, an electronic transaction type associated with the electronic transaction, wherein the electronic transaction type is selected based at least in part on a payment for dispensing the good or service; and
determining, via at least one processor, a commission amount based at least in part on the electronic transaction type.

2. The method of claim 1, further comprising:
reducing the commission amount if time between an electronic transaction authorization and an electronic transaction settlement exceeds a predetermined time period.

3. The method of claim 1, further comprising:
reducing the commission amount if the difference between an electronic transaction authorization amount and an electronic transaction settlement amount exceeds a predetermined value.

4. The method of claim 1, further comprising:
increasing the commission amount if one or more electronic transaction types are received at a predefined time.

5. The method of claim 1, further comprising:
reducing the commission amount if time between an electronic transaction authorization and an electronic transaction settlement exceeds a predetermined time period.

6. The method of claim 1, further comprising:
determining a plurality of unsettled transactions, each of the plurality of unsettled transactions having an unsettled sale amount; and
charging a payee a fee equivalent to the unsettled sale amount for each of the plurality of unsettled transactions.

7. The method of claim 1, further comprising:
accruing a total commission amount, wherein the total commission amount comprises a sum of at least cumulative commission amounts and any fee deductions from the plurality of electronic transactions.

8. The method of claim 1, further comprising:
transferring to a payee, funds in an amount equal to the total commission amount upon reaching a predefined criteria.

9. The method of claim 8, wherein the predefined criteria comprises at least one of the following:
at a calendar interval;
when the total commission amount reaches a predetermined amount;
when a predetermined count of plurality of the electronic transactions is reached; or upon request by said designated payee, or a representative of the payee.

10. The method in accordance with claim 1, wherein the electronic transaction comprises at least one of the following:
a credit card transaction;
a cashless transaction;
a bill transaction;
a coin transaction;
a data exchange (DEX) data communication;
a multi-drop bus (MDB) data communication; or
a hotel key card transaction.

11. A commission centric network operation system comprising:
a server comprising a computer-readable medium with computer-implemented instructions operable to:
receive an electronic transaction associated with dispensing a good or service, wherein at least one state field is associated with the electronic transaction;
determine said electronic transaction type based at least in part on a payment for dispensing the good or service; and
determine a commission amount for the electronic transaction based at least in part on a type of electronic transaction, when the at least one state field is determined to be a predefined state.

12. The system of claim 11, wherein the server is further operable to:
reduce the commission amount if time between an electronic transaction authorization and an electronic transaction settlement exceeds a predetermined time period.

13. The system of claim 11, wherein the server is further operable to:
reduce the commission amount if the difference between an electronic transaction authorization amount and an electronic transaction settlement amount exceeds a predetermined value.

14. The system of claim 11, wherein the server is further operable to:
increase the commission amount if certain said electronic transaction types are received at a predefined time.

15. The system of claim 11, wherein the server is further operable to:
reduce the commission amount if time between an electronic transaction authorization and an electronic transaction settlement exceeds a predetermined time period.

16. The system of claim 15, wherein the server is further operable to:
determine a plurality of unsettled transactions, each of the plurality of unsettled transactions comprising an unsettled sale amount; and
charging a payee a fee equivalent to the unsettled sale amount for each of the plurality of unsettled transactions.

17. The system of claim 11, wherein the server is further operable to:
determine a total commission amount, the total commission amount comprising a sum cumulative of commission amounts and any fee deductions from the plurality of electronic transactions; and
transferring to a payee funds in an amount equal to the total commission amount upon reaching at least one predefined criteria.

18. A method for providing a commission to a merchant comprising:
receiving an electronic transaction associated with dispensing a good or service;
determining, via at least one processor, an electronic transaction type associated with the electronic transaction based at least in part on a payment for dispensing the good or service; and
determining, via at least one processor, a commission amount based at least in part on at least one of the following: volume of transactions, amount of transactions, a predefined fee, or electronic transaction type.

19. The method in accordance with claim 18, wherein the electronic transaction comprises at least one of the following:
a credit card transaction;
a cashless transaction;
a bill transaction;
a coin transaction;
a data exchange (DEX) data communication;
a multi-drop bus (MDB) data communication; or
a hotel key card transaction.
